(19) United States
(12) Patent Application Publication
(10) Pub. No.: US 2017/0148119 A1
(43) Pub. Date: May 25, 2017

(54) Method for Renting/Selling a Copyrighted Work over a Network

(71) Applicant: Tsung-Yu Chen, Tainan City (TW)

(72) Inventor: Tsung-Yu Chen, Tainan City (TW)

(21) Appl. No.: 15/186,598

(22) Filed: Jun. 20, 2016

(30) Foreign Application Priority Data
Nov. 20, 2015 (TW) 104138642

(51) Int. Cl. G06Q 50/18; G06Q 30/06

(52) U.S. Cl. CPC G06Q 50/184; G06Q 30/0601; G06Q 30/0645

(57) ABSTRACT

A method for renting/selling a copyrighted work over a network includes a login step, a renting/selling setting step, a network renting/selling step, a sublease setting step, and a network sublease step. In the sublease setting step, a consumer optionally proceeds with sublease setting on a network copyright renting/selling system during the time period of renting/selling. The sublease setting includes the sublease fee, registration of personal information and the bank account information of each subleasee, and the distribution ratio of the income from the sublease of the copyrighted work. In the network sublease step, another consumer selects the copyrighted work to be sublet on the network copyright renting/selling system. The network copyright renting/selling system permits the another consumer to unlimitedly read the copyrighted work during the time period of the sublease after payment. The income from the sublease is distributed according to the distribution ratio.

### BACKGROUND OF THE INVENTION

The present invention relates to a method for renting/selling a copyrighted work over a network and, more particularly, to a method permitting the renter to sublease a copyrighted work during the time period of renting/selling and distributing the profit from the sublease to the subleaser and the copyright owner according to the distribution ratio through operation of a network system.

Electronic copyrighted works, such as electronic books, films, and comics, spread over networks have become more popular. With regard to renting of a copyrighted work, currently available techniques include using a network renting/selling system to provide login through identity identification. After online payment on a renting/selling web page, a user can read the copyrighted work during a predetermined period of time which may range from three days to several months. When the predetermined period of time expires, the network renting/selling system terminates the authority to read the copyrighted work through a computer or a hand-held smart device.

To assure the consumer has sufficient time to read, the network renting/selling system often sets an ample time period longer than the normal time period required by the consumer. Taking a movie as an example, the network renting/selling system often sets 3-5 days to permit the consumer to watch a 2-hour film. The time period may be up to a month in the case of an electronic book to avoid damage to the right of the consumer.

However, such a network renting/selling mode is advantageous to consumers having a low reading speed. Consumers having a high reading speed are often limited by the set time period and let the set time period lapse after having read the copyrighted work long before the deadline. The fixed time period is not suitable to efficient consumers and is, thus, not a renting/selling mode fulfilling the demands of consumers. However, current network renting/selling systems do not have a good solution to this problem, nor can they change the renting/selling time condition. Thus, current network renting/selling modes are defective in use.

### BRIEF SUMMARY OF THE INVENTION

A method for renting/selling a copyrighted work over a network according to the present invention includes:

a login step: a copyright owner of a work logs in a network copyright renting/selling system and registers an identify and bank account information of the copyright owner in the network copyright renting/selling system;

a renting/selling setting step: the copyright owner proceeds with setting of renting/selling conditions of the copyrighted work, the renting/selling conditions include a distribution ratio of an income from renting/selling the copyrighted work, distribution information of the copyrighted work, renting/selling fee of the copyrighted work, and a time period of renting/selling the copyrighted work, and wherein the distribution ratio of the income from renting/selling the copyrighted work includes a distribution ratio of the income from renting/selling the copyrighted work between the network copyright renting/selling system and the copyright owner;

a network renting/renting step: the copyrighted work is published on the network copyright renting/selling system, a consumer browses the network copyright renting/selling system, selects the copyrighted work to be read, and proceeds with a sublease, wherein after the network copyright renting/selling system has received payment from the consumer, the network copyright renting/selling system electrically transfers a portion of the renting/selling fee to the copyright owner according to the distribution ratio set in the renting/selling setting step;

a sublease setting step: the consumer optionally proceeds with sublease setting on a renting/selling web page of the network copyright renting/selling system during the time period of renting/selling, the sublease setting includes sublease fee, registration of personal information and bank account information of each subleasee, and a distribution ratio of an income from sublease of the copyrighted work, wherein a proportional fee distributed to the network copyright renting/selling system by the sublease setting step is distributed to the copyright owner according to the distribution ratio set in the renting/selling setting step, and a renting/selling web page platform of the network copyright renting/selling system publishes the sublease information to another consumers; and

a network sublease step: one of the another consumers selects the copyrighted work to be sublet on the renting/selling web page platform of the network copyright renting/selling system, the network copyright renting/selling system permits the one of the another consumers to unlimitedly read the copyrighted work during the time period of sublease after the one of the another consumers has paid the sublease fee, the income from the sublease is distributed according to the distribution ratio set in the sublease setting step to proceed with a sublease feedback and an extension feedback, wherein the sublease feedback includes distributing the income from the sublease to the consumer in the sublease setting step, and wherein the extension feedback includes distributing the income from the sublease that has been distributed to the network copyright renting/selling system based on the sublease setting in the sublease setting step to the copyright owner according to the distribution ratio set in the renting/selling setting step.

In an example, after the copyright owner has registered copyright owner information in the network copyright renting/selling system and has uploaded information related to a content and completion of the copyrighted work to be rented/sold, the content of the registered information is not permitted to be altered without the consent of the manager of the network copyright renting/selling system after the network copyright renting/selling system has confirmed the registration.

In an example, the network copyright renting/selling system permits the consumer to electrically and unlimitedly read the copyrighted work during the time period of renting/selling after the consumer has paid in the network renting/selling step.

In an example, the network copyright renting/selling system distributes the income from the sublease of the copyrighted work according to the sublease distribution ratio after the sublease setting step is completed.

The present invention will become clearer in light of the following detailed description of illustrative embodiments of this invention described in connection with the drawings.

### DESCRIPTION OF THE DRAWINGS

FIG. 1 is a diagrammatic view illustrating steps of the system of an example according to the present invention.

FIG. 2 is a diagrammatic view illustrating a sublease procedure of the system according to the present invention.

FIG. 3 is a diagrammatic view illustrating another sublease procedure of the system according to the present invention.

### DETAILED DESCRIPTION OF THE INVENTION

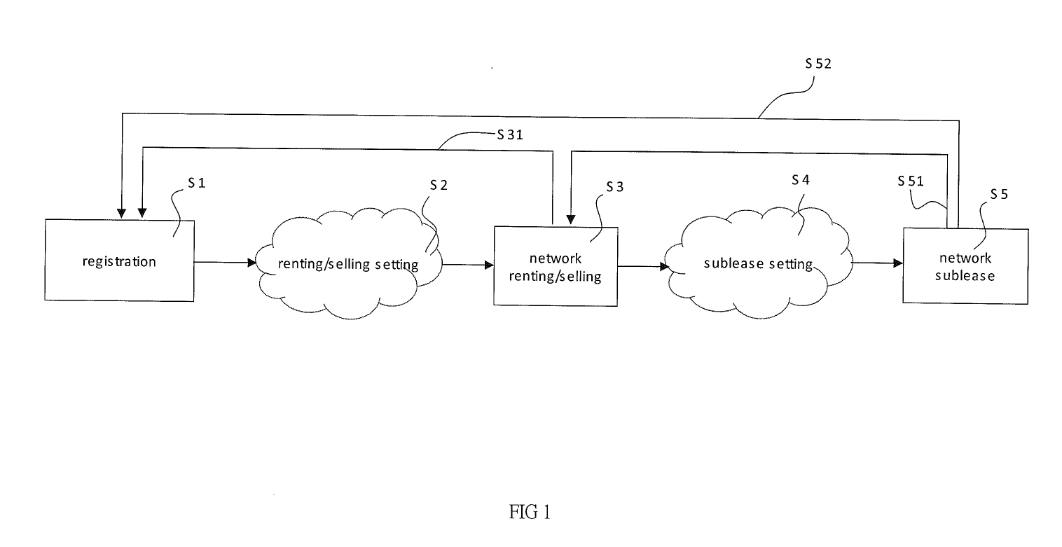

FIG. 1 is a diagrammatic view illustrating primary steps of a system of an example according to the present invention for carrying out a method for renting/selling a copyrighted work owned by a copyright owner C over a network. To solve the limitation of renting/selling time period in the conventional network renting/selling modes of copyrighted works, to achieve the best business interest of the copyrighted work during the renting/selling time period, and to assure desired revenue of the copyright owner from the copyrighted work, the present invention provides a network copyright renting/selling system 10 having a renting/selling web page platform to carry out the method according to the present invention.

The method includes a login step Si in which the copyright owner C logs in the network copyright renting/selling system 10 and enters information of the copyright owner C into the network copyright renting/selling system 10. The information of the copyright owner C includes the identity and the bank account information of the copyright owner C. Furthermore, the copyright owner C uploads information related to the content and completion of the copyrighted work to be rented/sold and defines the type of the copyrighted work. The type of the copyrighted work is classified according to the copyright law of the country (in which the network copyright renting/selling system 10 is located and in which renting/selling of the copyrighted work is conducted), such as writing works, figure works, and musical works. After the copyright owner C has registered the copyright owner information in the network copyright renting/selling system 10 and has uploaded information related to the content and completion of the copyrighted work to be rented/sold, the content of the registered information cannot be altered without the consent of the manager of the network copyright renting/selling system 10 after the network copyright renting/selling system 10 has confirmed the registration.

The method further includes a renting/selling setting step S2. After the login step S1, the copyright owner C proceeds with setting of the renting/selling conditions of the copyrighted work. The renting/selling conditions include the distribution ratio of the income from renting/selling the copyrighted work, the distribution information of the copyrighted work, the renting/selling fee of the copyrighted work, and the time period of renting/selling the copyrighted work. The distribution ratio of the income from renting/selling the copyrighted work includes the distribution ratio of the income from renting/selling the copyrighted work between the network copyright renting/selling system 10 and the copyright owner C. After the renting/selling setting, the income from renting/selling the copyrighted work can be distributed through the network copyright renting/selling system 10.

Then, in a network renting/renting step S3 after the renting/selling setting step S2, the copyrighted work is published on a renting/selling web page platform of the network copyright renting/selling system 10. A consumer browses the renting/selling web page platform of the network copyright renting/selling system 10, selects the copyrighted work to be read, and proceeds with a sublease. After the consumer has made the payment, the network copyright renting/selling system 10 permits the consumer to electrically and unlimitedly read the copyrighted work during the time period of renting/selling. After the network copyright renting/selling system 10 has received payment from the consumer, the network copyright renting/selling system 10 electrically transfers a portion of the renting/selling fee to the bank account of the copyright owner C registered in the network copyright renting/selling system 10 in the login step S1 according to the distribution ratio set in the renting/selling setting step S2 (the feedback S31).

A sublease setting step S4 can then be conducted. If the consumer has read the copyrighted work long before the deadline of the time period of renting/selling, the consumer can optionally proceed with sublease setting on the renting/selling web page platform of the network copyright renting/selling system 10 during the time period of renting/selling. The sublease setting includes the sublease fee, registration of personal information and bank account information of each subleasee, and the distribution ratio of the income from the sublease of the copyrighted work. Each sublease must confirm acceptance of the distribution ratio predetermined by the network copyright renting/selling system 10.

After the sublease setting, the network copyright renting/selling system 10 distributes the sublease income from the copyrighted work according to the distribution ratio of the sublease. A proportional fee distributed to the network copyright renting/selling system 10 by the sublease setting step S4 is distributed to the copyright owner C according to the distribution ratio set in the renting/selling setting step S2. The renting/selling web page platform of the network copyright renting/selling system 10 publishes the sublease information to another consumers.

A network sublease step S5 is carried out after the sublease setting step S4. After the sublease setting step S4, the copyrighted work to be sublet and the information of the remaining time period of renting/selling (the time period of the sublease) will be published on the renting/selling web page platform of the network copyright renting/selling system 10. Another consumer can select the copyrighted work to be sublet on the renting/selling web page platform of the network copyright renting/selling system 10 and can proceed with a sublease. After payment by this another consumer, the network copyright renting/selling system 10 permits this another consumer to unlimitedly read the copyrighted work during the time period of sublease. Furthermore, after payment by this another consumer, the income from the sublease is distributed according to the distribution ratio set in the sublease setting step S4 to proceed with a sublease feedback S51 and an extension feedback S52. The sublease feedback S51 includes distributing the income from the sublease to the bank account of the consumer in the sublease setting step S4 through electrical transfer. The extension feedback S52 includes distributing the income from the sublease that has been distributed to the network copyright renting/selling system 10 based on the sublease setting in the sublease setting step S4 to the copyright owner C according to the distribution ratio set in the renting/selling setting step S2.

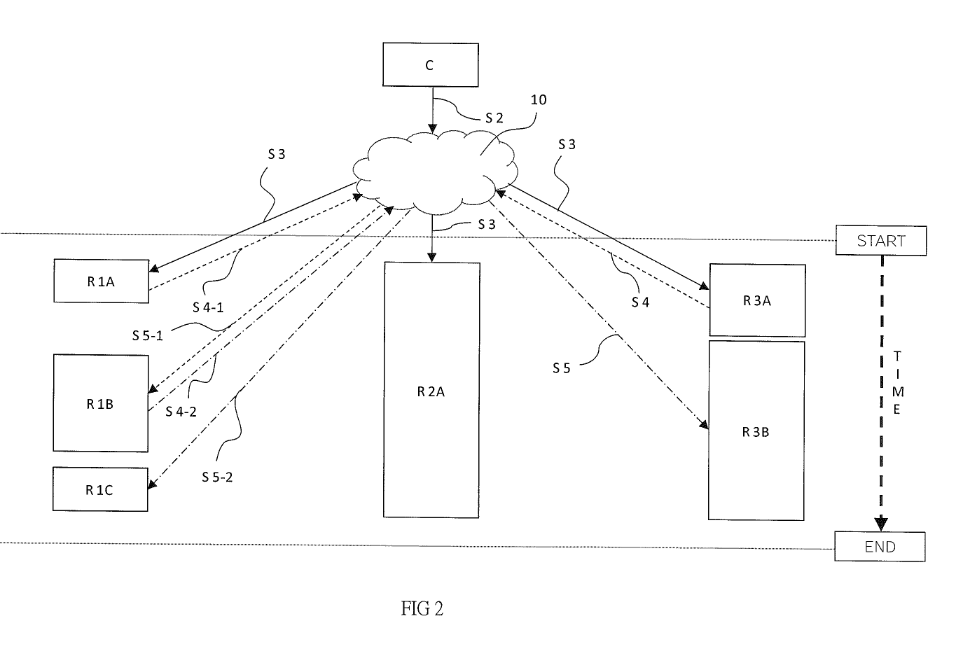

FIG. 2 is a diagrammatic view illustrating a sublease procedure of the system according to the present invention. According to the above steps S1 -S5, in the method for renting/selling a copyrighted work over a network according to the present invention, the login steps S1 provides the copyright owner C with clear setting of the distribution ratio of the income from the copyrighted work, assuring each revenue of renting/selling. Furthermore, a platform for registering and managing the source of a copyrighted work is provided. The copyright owner C can clearly register the information of the copyrighted work through regular registration to obtain a copyright source registration meeting the regulations of the copyright law, which is a copyright network platform with a better propagating effect for independent authors.

In the steps of the method according to the present invention, by providing the sublease setting step S4 and the network sublease step S5, it can be appreciated that the copyrighted work can be rented or sold to consumers R1A, R2A, and R3A through the network copyright renting/selling system 10. Due to different reading habits, consumer R1A has the fastest reading speed and finishes reading during the time period (TIME between START and END) in the renting/selling setting step S2. In this case, consumer R1A can proceed with a first sublease setting step S4-1 on the renting/selling web page platform of the network copyright renting/selling system 10. During this procedure, consumer R1A can selectively set the sublease fee (which is cheaper than the renting/selling fee) according to the remaining portion of the time period (TIME) of renting/selling and can propagate to other consumers by the renting/selling web page platform of the network copyright renting/selling system 10 in a network sublease step S5-1.

A second consumer R1B obtaining the sublease information can read the sublet copyrighted work after paying the sublease fee. If the second consumer RIB finishes reading the sublet copyrighted work before the deadline of the sublease time period, the second consumer R1B can proceed with a second sublease setting step S4-2 and then propagate to a third consumer R1C by the renting/selling web page platform of the network copyright renting/selling system 10 in a network sublease step S5-2 in a manner similar to the above.

In a case of a slow reading condition of consumer R2A, since consumer R2A takes a longer time to read the copyrighted work, consumer R2A can decide not to sublease the copyrighted work. In the reading condition of consumer R3A, the remaining time period permits the consumer R3A to sublease the copyrighted work to a second consumer R3B. The sublease of the present invention can be set to be different in terms of the time period of the sublease and the sublease fee to provide differences in the establishment speed of the sublease or the sublease revenue, all of which are advantageous to the benefit of the copyrighted work in the renting/selling market. The method of the present invention adds the sublease setting step S4 and the network sublease step S5 into the conventional time period of renting/selling to permit the consumer to proceed with the sublease according to his or her time schedule, such that the consumption of the electric copyrighted work can have the most efficient use.

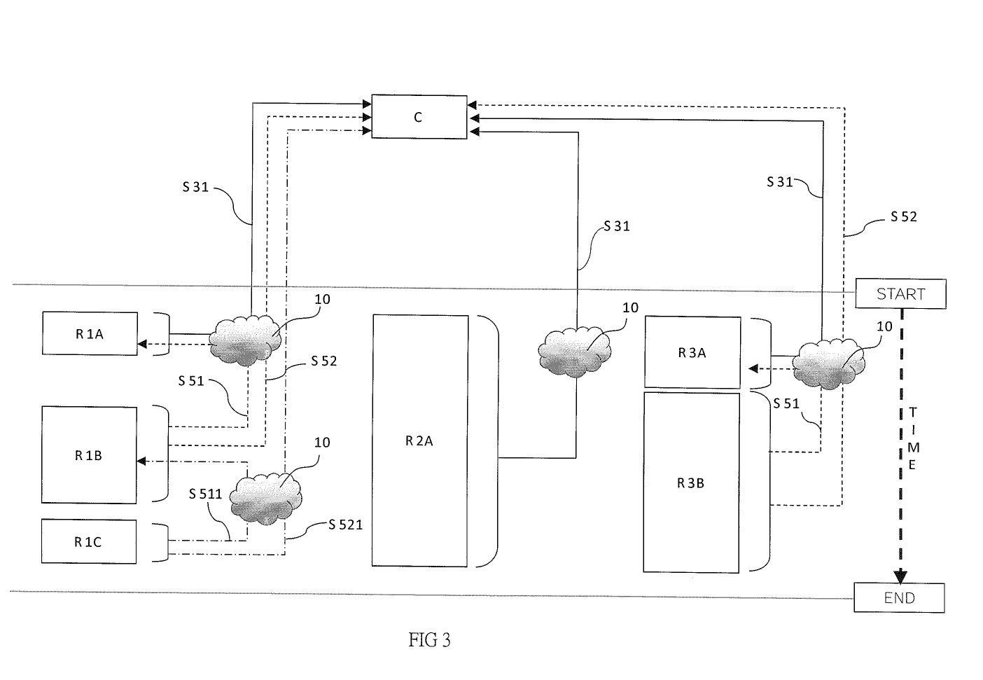

FIG. 3 is a diagrammatic view illustrating another example of the sublease setting step S4 and the network sublease step S5 of the sublease procedure of the system according to the present invention. After the renting/selling setting step S2 and during the time period (TIME between START and END), distribution can be conducted through the network copyright renting/selling system 10 after each consumption behavior is made. Particularly, after the login step S1, each consumption expenditure can be fed back in the network renting/selling step S3 (the feedback S31) to the copyright owner C in a public distribution mechanism. Alternatively, in the network sublease step S5, the profit from extended sublease of the copyrighted work can be fed back to the copyright owner C through the sublease setting of the consumers and the extension feedback S52. The consumers are not limited by the conventional time period of consumption that leads to a waste in the remaining portion of the time period (TIME) of renting/selling. The consumers can rent/sell the remaining portion of the time period (TIME) to the second consumers in the sublease setting step S4 and the sublease feedback S51 of the network sublease step S5 to reduce the burden of the consumer. The second consumers have reduced burden for renting/selling and can read the copyrighted work at a lower renting/selling fee.

Although specific embodiments have been illustrated and described, numerous modifications and variations are still possible without departing from the scope of the invention. The scope of the invention is limited by the accompanying claims.

1. A method for renting/selling a copyrighted work over a network, comprising:
a login step: a copyright owner of a work logs in a network copyright renting/selling system and registers an identify and bank account information of the copyright owner in the network copyright renting/selling system;
a renting/selling setting step: the copyright owner proceeds with setting of renting/selling conditions of the copyrighted work, the renting/selling conditions include a distribution ratio of an income from renting/selling the copyrighted work, distribution information of the copyrighted work, renting/selling fee of the copyrighted work, and a time period of renting/selling the copyrighted work, and wherein the distribution ratio of the income from renting/selling the copyrighted work includes a distribution ratio of the income from renting/selling the copyrighted work between the network copyright renting/selling system and the copyright owner;
a network renting/renting step: the copyrighted work is published on the network copyright renting/selling system, a consumer browses the network copyright renting/selling system, selects the copyrighted work to be read, and proceeds with a sublease, wherein after the network copyright renting/selling system has received payment from the consumer, the network copyright renting/selling system electrically transfers a portion of the renting/selling fee to the copyright owner according to the distribution ratio set in the renting/selling setting step;
a sublease setting step: the consumer optionally proceeds with sublease setting on a renting/selling web page of the network copyright renting/selling system during the time period of renting/selling, the sublease setting includes sublease fee, registration of personal information and bank account information of each subleasee, and a distribution ratio of an income from sublease of the copyrighted work, wherein a proportional fee distributed to the network copyright renting/selling system by the sublease setting step is distributed to the copyright owner according to the distribution ratio set in the renting/selling setting step, and a renting/selling web page platform of the network copyright renting/selling system publishes the sublease information to another consumers; and
a network sublease step: one of the another consumers selects the copyrighted work to be sublet on the renting/selling web page platform of the network copyright renting/selling system, the network copyright renting/selling system permits the one of the another consumers to unlimitedly read the copyrighted work during the time period of sublease after the one of the another consumers has paid the sublease fee, the income from the sublease is distributed according to the distribution ratio set in the sublease setting step to proceed with a sublease feedback and an extension feedback, wherein the sublease feedback includes distributing the income from the sublease to the consumer in the sublease setting step, and wherein the extension feedback includes distributing the income from the sublease that has been distributed to the network copyright renting/selling system based on the sublease setting in the sublease setting step to the copyright owner according to the distribution ratio set in the renting/selling setting step.

2. The method for renting/selling a copyrighted work over a network as claimed in claim 1, wherein after the copyright owner has registered copyright owner information in the network copyright renting/selling system and has uploaded information related to a content and completion of the copyrighted work to be rented/sold, the content of the registered information is not permitted to be altered without the consent of the manager of the network copyright renting/selling system after the network copyright renting/selling system has confirmed the registration.

3. The method for renting/selling a copyrighted work over a network as claimed in claim 1, wherein the network copyright renting/selling system permits the consumer to electrically and unlimitedly read the copyrighted work during the time period of renting/selling after the consumer has paid in the network renting/selling step.

4. The method for renting/selling a copyrighted work over a network as claimed in claim 1, wherein the network copyright renting/selling system distributes the income from the sublease of the copyrighted work according to the sublease distribution ratio after the sublease setting step is completed.
